(19) United States
(12) Patent Application Publication
(10) Pub. No.: US 2009/0256483 A1
(43) Pub. Date: Oct. 15, 2009

(54) Load Control Device Having a Visual Indication of an Energy Savings Mode

(75) Inventors: Jackson Gehman, Coopersburg, PA (US); Gregory Altonen, Easton, PA (US); Joel S. Spira, Coopersburg, PA (US)

Correspondence Address: LUTRON ELECTRONICS CO., INC.;MARK E. ROSE, 7200 SUTER ROAD, COOPERSBURG, PA, 18036-1299, US

(73) Assignee: LUTRON ELECTRONICS CO., INC., Coopersburg, PA (US)

(21) Appl. No.: 12/474,950

(22) Filed: May 29, 2009

Related U.S. Application Data
(63) Continuation-in-part of application No. 11/514,659, filed on Sep. 1, 2006.
(60) Provisional application No. 60/812,337, filed on Jun. 8, 2006.

(51) Int. Cl. H05B 37/02

(52) U.S. Cl. 315/129

(57) ABSTRACT

A load control system (e.g., a dimmer switch) operates in a normal mode of operation and an energy-saver mode and displays a visual indication when the system is operating in the energy-saver mode. The system comprises a controllably conductive device adapted to be coupled in series between a power source and a lighting load, a control circuit operatively coupled to the controllably conductive device for adjusting the intensity of the lighting load, and a visual indicator for providing the visual indication that the system is in the energy-saver mode of operation. The control circuit controls the intensity of the lighting load between a minimum intensity and a first maximum intensity when the system is in the normal mode of operation, and between the minimum intensity and a second maximum intensity less than the first maximum intensity when the system is in the energy-saver mode.

### CROSS REFERENCES TO RELATED APPLICATIONS

The present application is a continuation-in-part of co-pending, commonly-assigned U.S. patent application Ser. No. 11/514,659, filed Sep. 1, 2006, entitled DIMMER SWITCH WITH ADJUSTABLE HIGH-END TRIM, which claims priority from U.S. Provisional Patent Application Ser. No. 60/812,337, filed Jun. 8, 2006, entitled DIMMER WITH ADJUSTABLE HIGH-END TRIM. The entire disclosures of both applications are hereby incorporated by reference.

### BACKGROUND OF THE INVENTION

1. Field of the Invention

The present invention relates to a load control device for controlling the amount of power delivered to an electrical load, and more particularly, to a dimmer switch that is able to operate in a normal mode of operation and an energy-saver mode and to display a visual indication that the dimmer switch is in the energy-saver mode.

2. Description of the Related Art

A conventional wall-mounted load control device is mounted to a standard electrical wall box and is coupled between a source of alternating-current (AC) power (typically 50 or 60 Hz line voltage AC mains) and an electrical load, such as a lighting load. Standard load control devices (such as dimmer switches) use one or more semiconductor switches, typically bidirectional semiconductor switches, such as triacs or field effect transistors (FETs), to control the current delivered to the load, and thus, the intensity of the light provided by the lighting load between a maximum intensity and a minimum intensity. The semiconductor switch is typically coupled in series between the source and the lighting load. Using a phase-control dimming technique, the dimmer switch renders the semiconductor switch conductive for a portion of each line half-cycle to provide power to the lighting load, and renders the semiconductor switch non-conductive for the other portion of the line half-cycle to disconnect power from the load. The ratio of the on-time, during which the semiconductor switch is conductive, to the off-time, during which the semiconductor switch is non-conductive, determines the intensity of the light produced by the lighting load.

Wall-mounted dimmer switches typically include a user interface having a means for adjusting the lighting intensity of the load, such as a linear slider, a rotary knob, a rocker switch, or a push button. Dimmer switches also typically include a button or switch that allows for toggling of the load from off (i.e., no power is conducted to the load) to on (i.e., power is conducted to the load), and vice versa.

Many people desire to save energy. Because a dimmer switch use the phase-controlled dimming technique described above (i.e., the bidirectional semiconductor switch is rendered non-conductive for a portion of each half-cycle), the dimmer switch is operable to provide more energy savings as compared to a standard switch. More particularly, one way to save even more energy with a dimmer switch is to adjust the high-end trim of the dimmer switch to limit the maximum amount of power that the dimmer switch will deliver to the lighting load. The high-end trim is the maximum amount of power that a dimmer switch is capable of delivering to a lighting load. The high-end trim is determined by the maximum possible on-time of the semiconductor switch. In contrast, the low-end trim is the minimum amount of power that a dimmer switch is capable of delivering to a lighting load, when the dimmer is on. The low-end trim is determined by the minimum possible on-time of the semiconductor switch when the semiconductor switch is conducting. Prior art dimmer switches typically have fixed high-end trims and provide no user-accessible means for a user to be able to change the high-end trim, and further provide no visual indication that the high-end trim has been adjusted.

There is a need for a lighting control device, such as a dimmer switch, that has a user-accessible means for adjusting the high-end trim without changing the low-end trim, and that provides a visual indication that the high-end trim has been adjusted.

### SUMMARY OF THE INVENTION

According to an embodiment of the present invention, a system for controlling the amount of power delivered from a power source to a lighting load for adjusting an intensity of the lighting load comprises a controllably conductive device, a control circuit operable to change between a normal mode of operation and an energy-saver mode, and a visual indicator operable to provide a visual indication that the control circuit is in the energy-saver mode of operation. The controllably conductive device is adapted to be coupled in series electrical connection between the source and the load for controlling the amount of power delivered to the load, and the control circuit is operatively coupled to the controllably conductive device for adjusting the intensity of the lighting load. The control circuit controls the intensity of the lighting load between a minimum intensity and a first maximum intensity when the dimmer switch is in the normal mode of operation, and between the minimum intensity and a second maximum intensity when the dimmer switch is in the energy-saver mode, where the second maximum intensity is less than the first maximum intensity.

According to another embodiment of the present invention, a control system for controlling the amount of power delivered to a lighting load from an electrical power source comprises a dimmer circuit, a first control structure, a second control structure, and an indicator. The dimmer circuit is adapted to be coupled in series electrical connection between the power source and the lighting load for controlling the amount of power delivered to the lighting load. In response to the operation of the first control structure, the dimmer circuit controllably adjusts the power applied to the load to an initial value in a range between a high rated value and a lower value. In response to the operation of the second control structure, the dimmer circuit reduces the power applied to the load as set by the first control structure by a reduction amount that is dependent upon the initial value. The indicator is responsive to the second control structure to provide a visual indication when the dimmer circuit has reduced the power applied to the load as set by the first control structure by the reduction amount.

According to yet another embodiment of the present invention, a wallbox dimmer switch is adapted to be coupled between a power source and an electrical load for controlling the amount of power delivered to the electrical load between a maximum value and a minimum value. The wallbox dimmer switch comprises a dimmer circuit for controlling the power applied to the load between the full power value and the reduced value, a first manually-operable control structure for controlling the dimmer circuit, a second manually-operable control structure, and an indicator lamp operable to be illuminated in response to the second manually-operable control structure. The dimmer circuit reduces the amount of power applied to the load as called for by the first manually-operable control structure. The reduction of the amount of power responsive to the actuation of the second manually-operable control structure is functionally related to the amount of power being supplied to the load when the second manually-operable control structure is actuated.

In addition, a process of saving energy supplied from a power source to a load is a also described herein. The process comprises the steps of: (1) providing a dimmer circuit operable to controllably adjust the amount of power applied to the load by the manual operation of a first manually-operable control structure; (2) operating a second manually-operable control structure to reduce the amount of power applied to the load beyond that called for by the first manually-operable control structure; and (3) illuminating of an indicator lamp when the second manually-operable control structure is actuated. The power reduction is functionally related to the amount of power being supplied to the load when the second manually-operable control structure is actuated.

Other features and advantages of the present invention will become apparent from the following description of the invention that refers to the accompanying drawings.

### BRIEF DESCRIPTION OF THE DRAWINGS

For the purpose of illustrating the invention, there is shown in the drawings a form, which is presently preferred, it being understood, however, that the invention is not limited to the precise arrangements and instrumentalities shown. The features and advantages of the present invention will become apparent from the following description of the invention that refers to the accompanying drawings, in which:

FIG. 1 is a perspective view of a wallbox dimmer switch having a visual indicator for displaying an indication when the dimmer switch is in an energy-saver mode according to a first embodiment of the present invention;

FIG. 2 is another perspective view of the dimmer switch of FIG. 1;

FIG. 3A is a perspective view of the dimmer switch of FIG. 1 showing an energy-saver mode adjustment actuator in a first position, such that the dimmer switch is in the energy-save mode and is providing the indication that the dimmer switch is in the energy-saver mode according;

FIG. 3B is a perspective view of the dimmer switch of FIG. 1 showing the energy-saver mode adjustment actuator in a second position, such that the dimmer switch is not in the energy-save mode;

FIG. 4 is a simplified schematic diagram of the dimmer switch of FIG. 1 according to a first embodiment of the present invention;

FIG. 5 is a plot of the power delivered to a lighting load controlled by the dimmer switch of FIG. 1 versus the position of a slider actuator of the dimmer switch when operated in a normal mode and an energy saver mode;

FIG. 6 is a front view of a “smart” wallbox dimmer switch that provides a visual indication when the dimmer switch is in an energy-saver mode according to a second embodiment of the present invention;

FIG. 7A is a simplified block diagram of the dimmer switch of FIG. 6;

FIG. 7B is a simplified block diagram of a remote control for wirelessly controlling the dimmer switch of FIG. 6;

FIG. 8A is a simplified flowchart of a button procedure executed by a controller of the remote control of FIG. 7B;

FIG. 8B is a simplified flowchart of a TX timer procedure executed by the controller of the remote control of FIG. 7B;

FIG. 8C is a simplified flowchart of the transmit procedure executed by the controller of the remote control of FIG. 7B;

FIGS. 9A and 9B are simplified flowcharts of a receive procedure executed by a controller of the dimmer switch of FIG. 7A;

FIG. 10 shows a front view of a smart wallbox dimmer switch that provides a visual indication that the dimmer switch is in an energy-saver mode according to a third embodiment of the present invention;

FIG. 11 is a simplified block diagram of a centralized lighting control system that is able to operate in an energy-saver mode according to a fourth embodiment of the present invention; and

FIG. 12 is a simplified flowchart of a control procedure executed by a central processor of the lighting control system of FIG. 11.

### DETAILED DESCRIPTION OF EMBODIMENTS OF THE INVENTION

The foregoing summary, as well as the following detailed description of the preferred embodiments, is better understood when read in conjunction with the appended drawings. For the purposes of illustrating the invention, there is shown in the drawings an embodiment that is presently preferred, in which like numerals represent similar parts throughout the several views of the drawings, it being understood, however, that the invention is not limited to the specific methods and instrumentalities disclosed.

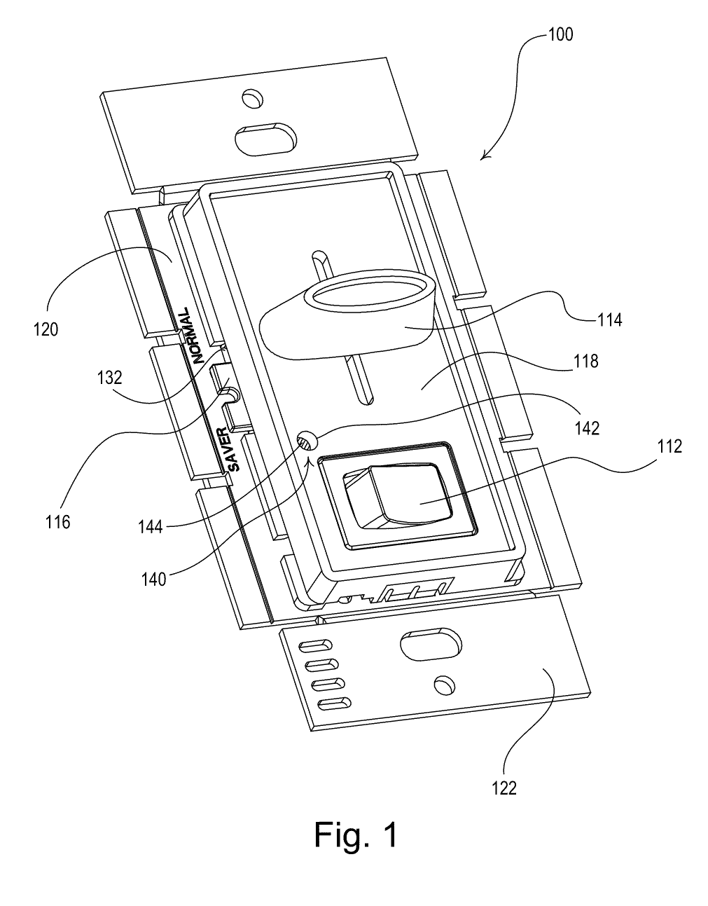

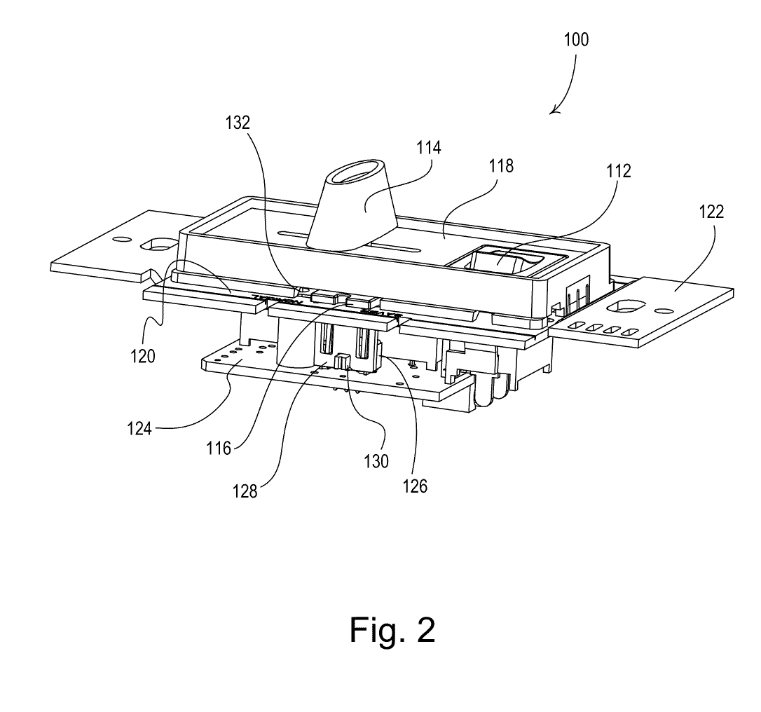

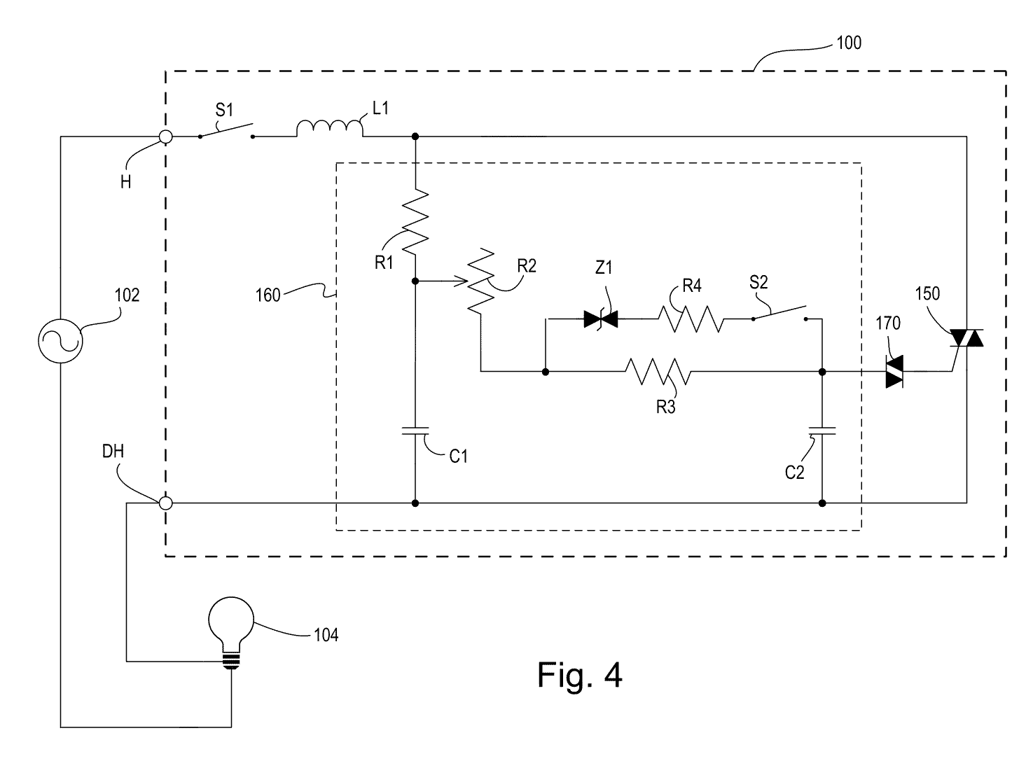

FIGS. 1 and 2 are perspective views of the user interface of a wallbox dimmer switch 100 that provides an energy-saver (ES) mode according to a first embodiment of the present invention. The dimmer switch 100 is adapted to be wall-mounted in a standard electrical wallbox. The dimmer switch 100 includes a dimmer circuit for controlling the amount of power delivered from an alternating-current (AC) source 102 (FIG. 4) and a lighting load 104 (FIG. 4), such as an electric lamp. The dimmer switch 100 also comprises a user interface having a rocker switch 112, an intensity adjustment actuator (e.g., a slider actuator 114), and an energy-saver mode adjustment actuator 116. The rocker switch 112 allows for turning on and off the lighting load 104, while the slider actuator 114 allows for adjustment of the amount of power delivered to the lighting load 104 and thus for adjustment of a present lighting intensity L (i.e., a perceived lighting intensity) of the lighting load 104. The perceived lighting intensity is equal to approximately the square-root of a measured lighting intensity (i.e., in lumens), which is commonly known as “square-law dimming”. Since the present lighting intensity L of the lighting load 104 is dependent upon the amount of power being delivered to the lighting load 104, the dimmer switch 100 is operable to save energy by dimming the lighting load 104 using the phase-controlled dimming technique (as described above).

The present lighting intensity L of the lighting load 104 may be adjusted across a dimming range between a low-end lighting intensity L_{LE} (e.g., approximately 5% of a maximum possible intensity L_{MAX}) and a high-end lighting intensity L_{HE} (e.g., approximately 92% of the maximum possible intensity L_{MAX}). The maximum possible intensity L_{MAX} is the intensity of the lighting load 104 if the lighting load is coupled directly to the power source 102 or if the lighting load is controlled by a standard switch. Due to internal circuitry, the dimmer switch 100 is not able to control the lighting intensity L of the lighting load 104 above the high-end lighting intensity L_{HE} or below the low-end lighting intensity L_{LE}. However, the dimmer switch 100 can turn the lighting load off (i.e., control the lighting intensity L to approximately 0%).

The energy-saver mode adjustment actuator 116 allows a user to change the dimmer switch 100 between a normal operating mode and an energy-saver mode. When the dimmer switch 100 is in the normal operating mode, the high-end lighting intensity L_{HE} is set at a nominal high-end intensity L_{HE-NOM} (e.g., approximately 92% of the maximum possible intensity L_{MAX}). When the dimmer switch 100 is in the energy-saver mode, the high-end lighting intensity L_{HE} is set at a reduced high-end intensity L_{HE-ES} (e.g., approximately 85% of the maximum possible intensity L_{MAX}). The amount of power that is delivered to the lighting load 104 when the present lighting intensity L is at the reduced high-end intensity L_{HE-ES} may comprise an appropriate amount of power that causes the lighting load to save energy (as compared to the nominal high-end intensity L_{HE-NOM}), while still providing an appropriate amount of illumination to perform tasks in the space illuminated by the lighting load. Particularly, the difference in the illumination provided by the lighting load 104 at the reduced high-end intensity L_{HE-ES} and at the nominal high-end intensity L_{HE-NOM} is imperceptible to most users, which may be achieved when the reduced high-end intensity L_{HE-ES} is approximately 85%. Accordingly, the dimmer switch 100 uses less energy when the dimmer switch is in the energy-saver mode.

The dimmer switch 100 also includes a bezel 118 attached to a front surface 120 of a mounting yoke 122 and a printed circuit board 124 mounted inside the dimmer switch 100. The bezel 118 is adapted to be received in an opening of a faceplate (not shown). The energy-saver mode adjustment actuator 116 is coupled, via a coupling member 128, to a mechanical switch 126 mounted on the printed circuit board 124. The mechanical switch 126 includes an actuation knob 130, which is received in a notch in the coupling member. The energy-saver mode adjustment actuator 116 is provided through an opening 132 of the mounting yoke 122, such that the user is able to change the dimmer switch 100 between the normal mode of operation and the energy-saver mode from the user interface of the dimmer switch. The energy-saver mode adjustment actuator 116 is located such that the adjustment actuator cannot be seen when the faceplate is mounted to the dimmer switch 100, but can be accessed when the faceplate is removed.

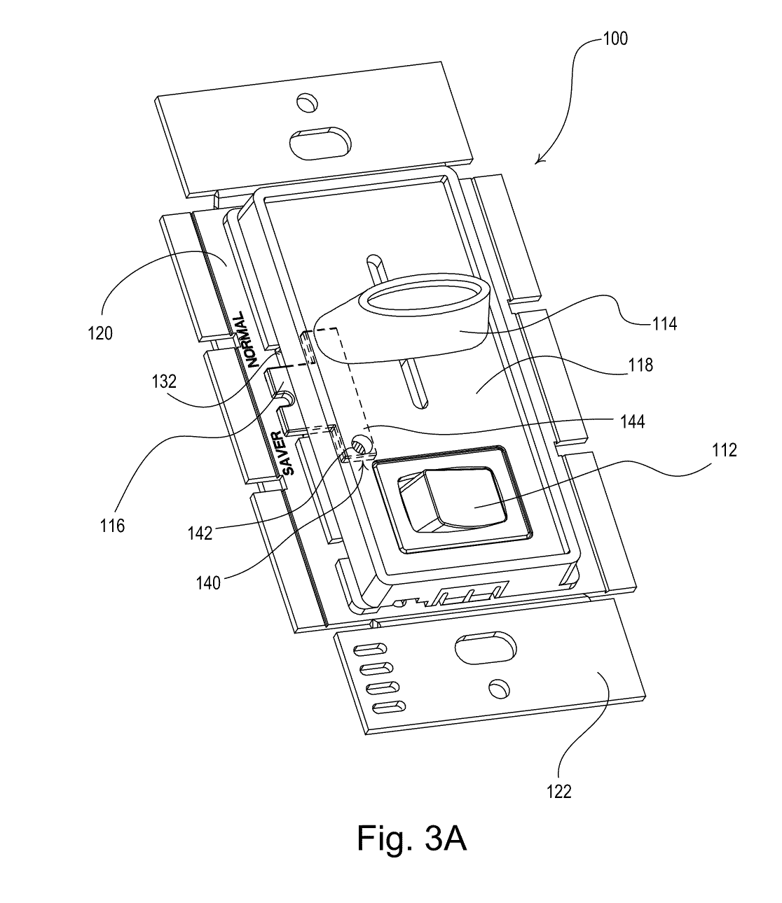

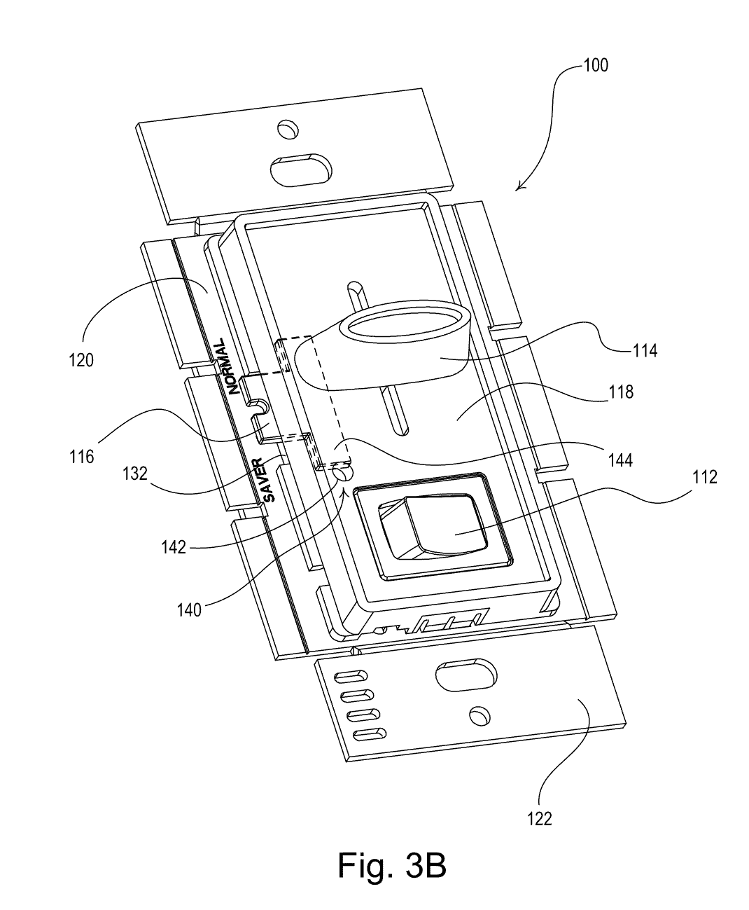

According to the first embodiment of the present invention, the dimmer switch 100 comprises a visual indicator 140 that provides an indication of when the dimmer switch is in the energy-saver mode. The visual indicator 140 comprises a mechanical flag that can be seen through an opening 142 in the bezel 118. Specifically, the energy-saver mode adjustment actuator 116 includes an elongated portion 144 that can be seen through the opening 142 when the dimmer switch 100 is in the energy-saver mode (as shown in FIG. 3A). For example, the elongated portion 144 of the energy-saver mode adjustment actuator 116 may be colored green, such that the visual indicator 140 displays green when the dimmer switch 100 is in the energy-saver mode. When the dimmer switch 100 is in the normal mode, the elongated portion 144 cannot be seen through the opening 142 in the bezel 118 (as shown in FIG. 3B).

FIG. 4 is a simplified electrical schematic diagram of the dimmer switch 100 according to a first embodiment of the present invention. The dimmer switch 100 includes a hot terminal H that is connected to an AC power source 102, and a dimmed hot terminal DH that is connected to the lighting load 104. The dimmer switch 100 includes a switch S1 connected to the hot terminal H and a choke L1 connected in series with the switch S1. The dimmer circuit of the dimmer switch 100 comprises a triac 150 connected in series between the choke L1 and the dimmed hot terminal DH. The triac 150 may alternatively be replaced by any suitable bidirectional switch, such as, for example, a field-effect transistor (FET) or an insulated gate bipolar junction transistor (IGBT) in a rectifier bridge, two FETs in anti-series connection, two IGBTs in anti-series connection, or a pair of silicon-controlled rectifiers. The switch S1 is the electrical representation of the rocker switch 112 of the user interface of the dimmer switch 100. When the switch S1 is open, no power is delivered to the lighting load 104. When the switch S1 is closed, the dimmer switch 100 is operable to control the amount of power delivered to the lighting load 104. The choke L1 operates as an electromagnetic interference (EMI) filter.

A timing circuit 160 is connected in parallel with the main leads of the triac 150. A diac 170 is connected in series between an output of the timing circuit 160 and a control lead (i.e., a gate) of the triac 150. The diac 170 may alternatively be replaced by any suitable triggering circuit or triggering device, such as, for example, a silicon bilateral switch (SBS). The timing circuit 160 comprises a firing capacitor C2, which produces a firing voltage for turning on the triac after a selected phase angle in each line voltage half-cycle and may have, for example, a capacitance of approximately 0.1° F. The diac 170 has a breakover voltage V_{BR} (for example, approximately 30V), and will conduct current to and from the triac control lead only when the firing voltage on the capacitor C2 exceeds substantially the breakover voltage V_{BR} of the diac 170. A gate current flows into the control lead of the triac 150 during the positive half-cycles of the line voltage and out of the control lead of the triac 150 during the negative half-cycles.

The timing circuit 160 includes a resistor R1 and a capacitor C1, which are coupled in series between the inductor L1 and the dimmed hot terminal DH. For example, the resistor R1 may have a resistance of approximately 5.6 kΩ and the capacitor C1 may have a capacitance of approximately 0.1° F. A wiper lead (or adjustable arm) of a potentiometer R2 is connected to the junction of the resistor R1 and the capacitor C1. The potentiometer R2 has a value that can be varied from a minimum resistance (e.g., approximately 0Ω) up to a maximum value (e.g., approximately 300 kΩ). The potentiometer R2 is coupled to the slider actuator 114 and allows a user to adjust the lighting intensity L of the attached lighting load 104 from the low-end lighting intensity L_{LE} to the high-end lighting intensity L_{HE}. The charging time of the capacitor C2 is varied in response to a change in the resistance of the potentiometer R2 to change the selected phase angle at which the triac 150 begins conducting. As the value of the potentiometer R2 is decreased, the capacitor C2 charges faster, thus causing the diac 170 to fire sooner and the triac 150 to be rendered conductive sooner in the half-cycle.

The timing circuit 160 comprises a normally open single-pole single-throw switch S2, which is the electrical representation of the mechanical switch 126 that is actuated by the user-accessible energy-saver mode adjustment actuator 116. When the switch S2 is closed, the dimmer switch 100 operates in the normal mode with the nominal high-end intensity L_{HE-NOM}. At this time, a resistor R3 (e.g., having a resistance of 31.6 kΩ) is coupled in parallel electrical connection with the series combination of a transient voltage suppressor Z1 and a resistor R4 (e.g., having a resistance of 100Ω). For example, the transient voltage suppressor Z1 may have a breakover voltage V_{Z} of about 33.3V, and may comprise a pair of Zener diodes connected in series in reverse order or a TransZorb® transient voltage suppressor (manufactured by Vishay Intertechnology). While the potentiometer R2 is at the minimum resistance and the switch S2 is closed, the firing voltage at the output of the timing circuit 160 increases from substantially zero volts to a predetermined voltage, i.e., the breakover voltage V_{BR} of the diac 170, during a first period of time, i.e., at a first rate. Accordingly, the capacitor C2 charges for the first period of time before the diac 170 fires.

In contrast, when the switch S2 is open, the dimmer switch 100 operates in the energy saver mode with the reduced high-end trim intensity L_{HE-ES}. While the potentiometer R2 is at the minimum resistance and the switch S2 is closed, the firing voltage at the output of the timing circuit 160 increases from substantially zero volts to the predetermined voltage during a second period of time, i.e., at a second rate. Accordingly, the capacitor C2 charges for the second period of time before the diac 170 fires. In both the normal mode and the energy saver mode, the user of the dimmer switch 100 may change the firing angle by using the slider actuator 114 to increase or decrease the amount of power delivered to the lighting load 104.

When switch S2 is closed (i.e., normal mode), the series combination of the transient voltage suppressor Z1 and the resistor R4 is connected in parallel with the resistor R3. When the voltage developed across the resistor R3 exceeds substantially the breakover voltage V_{Z} of the transient voltage suppressor Z1, the transient voltage suppressor Z1 conducts. Resistor R3 is then effectively short-circuited (since the resistance of resistor R4 is substantially small, i.e., 100Ω, compared to resistor R3). The total resistance in the charging path of the capacitor C2 is reduced, thereby shortening the time required for the capacitor C2 to charge to the breakover voltage V_{BR} of the diac 170. Thus, the triac 150 begins conducting earlier than it would if the switch S2 were open, thereby raising the high-end intensity L_{HE} to a higher level than when the switch S2 is open, i.e., with the nominal high-end intensity L_{HE-NOM}.

When the diac 170 fires, the voltage across the diac decreases to a breakback voltage V_{BB}, e.g., 25V. Since the voltage between the control input and the second main lead of the triac 150 is substantially zero volts, the voltage across the capacitor C2 decreases to substantially the breakback voltage V_{BB} of the diac 170, i.e., decreases by approximately five (5) volts. As a result, the voltage across the series combination of the transient voltage suppressor Z1, the resistor R4, and the switch S2 increases by this difference, i.e., approximately five volts. The resistor R4 operates to protect the transient voltage suppressor Z1 by limiting the current that is conducted through the transient voltage suppressor at this time, but could alternatively be replaced by a short circuit. Further, a transient voltage suppressor having a greater current rating could alternatively be used. The timing circuit 160 and alternate embodiments of the timing circuit are described in greater detail in the parent application, i.e., U.S. patent application Ser. No. 11/514,659.

Accordingly, the dimmer switch 100 provides a first manually-operable control structure (i.e., the slider actuator 114) for adjusting the present lighting intensity L of the lighting load 104 between the low-end intensity L_{LE} and the high-end intensity L_{HE}. The dimmer switch 100 further provides a second manually-operable control structure (i.e., the energy-saver mode adjustment actuator 116) for adjusting the high-end intensity L_{HE} between the nominal high-end intensity L_{HE-NOM} (i.e., a first maximum level) when the switch S2 is closed, and the reduced high-end trim intensity L_{HE-ES} (i.e., a second maximum level) when the switch S2 is open. The low-end intensity L_{LE} is not affected by the state of the switch S2 because, at the low-end intensity L_{LE}, the value of the resistance of the potentiometer R2 is sufficiently high so that the charging current through the capacitor C2 remains sufficiently small so that the voltage developed across the resistor R3 never exceeds the breakover voltage V_{Z} of the transient voltage suppressor Z1.

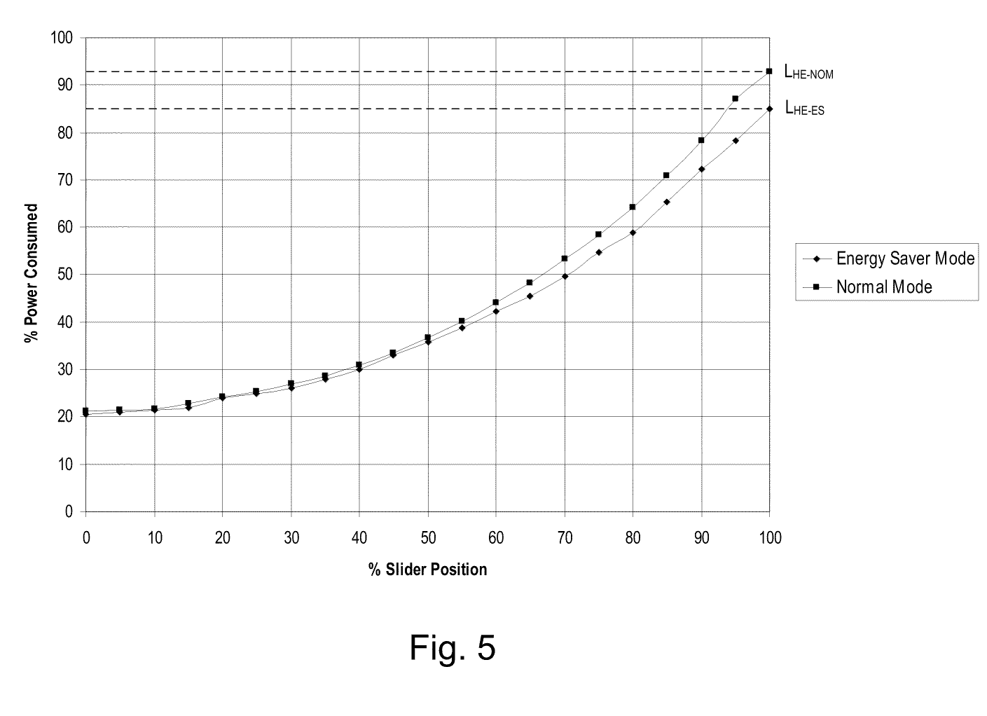

FIG. 5 is a plot of the power delivered to the lighting load 104 versus the position of a slider actuator 114 of the dimmer switch 100 when operated in the normal mode and the energy-saver mode. When the dimmer switch 100 is operated in the energy-saver mode, the power delivered to the lighting load 104 at a slider position of 100% (i.e., at the high-end intensity L_{HE}) is less than the power delivered to the lighting load at the high-end intensity L_{HE} when the dimmer switch is in the normal mode. As shown by FIG. 5, the power delivered to the lighting load 104 at a slider position of 0% (i.e., at the low-end intensity L_{LE}) is substantially the same when the dimmer switch is operating in the energy saver mode and the normal mode. In both modes, the dimmer switch 100 provides continuous dimming of the intensity of the lighting load 104 by varying the amount of power delivered to the lighting load 104 in response to varying the position of the slider actuator 114. In the normal mode, the dimming range is scaled between the nominal high-end intensity L_{HE-NOM} and the fixed low-end intensity L_{LE}. In the energy-saver mode, the dimming range is scaled between the reduced high-end trim intensity L_{HE-ES} and the fixed low-end intensity L_{LE}. Accordingly, when the energy-saver mode adjustment actuator 116 is actuated to change the dimmer switch 100 from the normal mode to the energy-saver mode, the present lighting intensity L of the lighting load 104 may be decreased by a reduction amount (i.e., from an initial lighting intensity to a resulting lighting intensity). The reduction amount and the resulting lighting intensity of the lighting load 104 are dependent upon the initial lighting intensity (i.e., the position of the slider actuator 114). Since the low-end intensity L_{LE} is fixed, the reduction amount may be equal to zero at the low-end intensity L_{LE}.

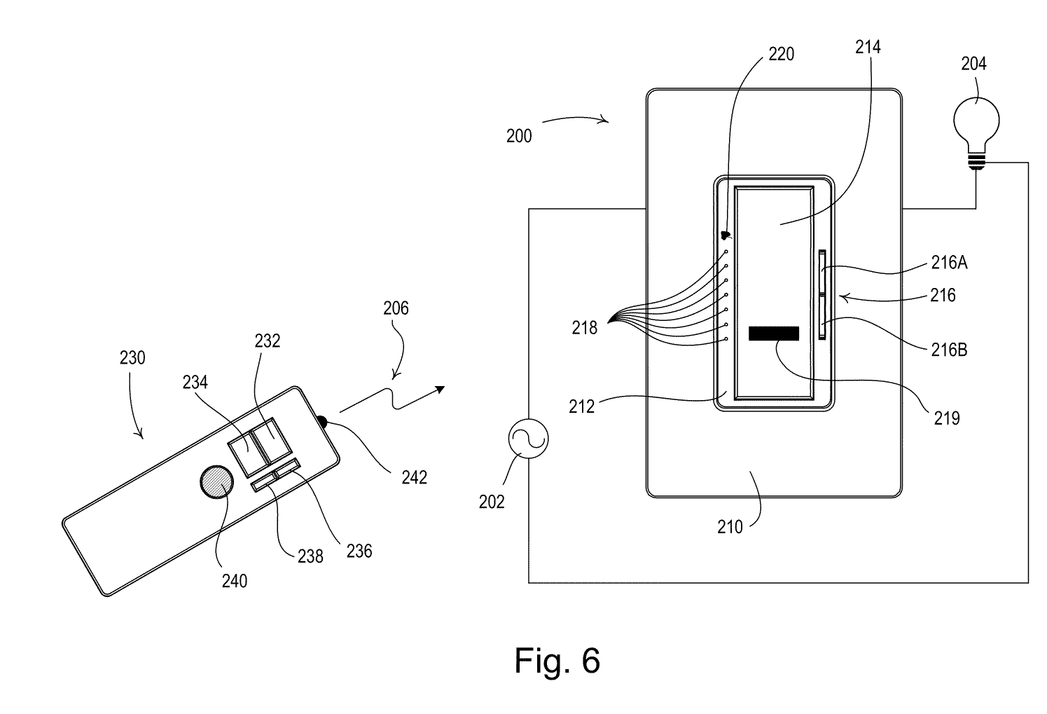

FIG. 6 shows a front view of a “smart” wallbox dimmer switch 200, which provides a visual indication that the dimmer switch 200 is in an energy-saver mode according to a second embodiment of the present invention. The dimmer switch 200 is adapted to be wall-mounted in a standard electrical wallbox. The dimmer switch 200 is operable to be coupled in series electrical connection between an AC power source 202 and an electrical lighting load 204 for controlling the amount of power delivered to the lighting load, and thus the present intensity L between the high-end intensity L_{HE} and the low-end intensity L_{LE}. The dimmer switch 200 comprises a faceplate 210 and a bezel 212 received in an opening of the faceplate. The dimmer switch 200 comprises a control actuator 214 and an intensity adjustment actuator (e.g., a rocker switch 216). Actuations of the control actuator 214 toggle, i.e., alternately turn off and on, the lighting load 204. The dimmer switch 200 may be programmed with a lighting preset intensity L_{PRE} (i.e., a “favorite” intensity level), such that the dimmer switch is operable to control the present intensity L of the lighting load 204 to the preset intensity L_{PRE} when the lighting load is turned on by an actuation of the control actuator 214. Actuations of an upper portion 216A or a lower portion 216B of the rocker switch 216 respectively increase or decrease the amount of power delivered to the lighting load 204 and thus increase or decrease the present intensity L of the lighting load 204.

A plurality of visual indicators 218, e.g., light-emitting diodes (LEDs), are arranged in a linear array on the left side of the bezel 212. The visual indicators 218 are illuminated to provide feedback of the present intensity of the lighting load 204. The dimmer switch 200 illuminates one of the plurality of visual indicators 218, which is representative of the present light intensity of the lighting load 204. Examples of smart dimmer switches are described in greater detail in U.S. Pat. No. 5,248,919, issued Sep. 29, 1993, entitled LIGHTING CONTROL DEVICE, and U.S. patent application Ser. No. 12/363,258, filed, entitled LOAD CONTROL DEVICE HAVING A VISUAL INDICATION OF ENERGY SAVINGS AND USAGE INFORMATION, the entire disclosures of which are both hereby incorporated by reference.

The dimmer switch further comprises an infrared (IR) lens 219 for receiving infrared signals 206 (i.e., wireless transmissions) from a remote control 230. The remote control 230 comprises an on button 232, an off button 234, a raise button 236, a lower button 238, and an energy-saver (ES) mode button 240. The remote control comprises an IR transmitter 242 (e.g., an infrared-emitting diode) for transmitting the IR signals 206 to the dimmer switch 200. The remote control 230 transmits packets (i.e., digital messages) via the IR signals 206 to the dimmer switch 200 in response to actuations of any of the actuators. A packet transmitted by the remote control 230 includes a preamble and a command (e.g., an on command, an off command, a raise command, a lower command, or an energy-saver mode command). The remote control 230 transmits packets to the dimmer switch 200 on a periodic basis (e.g., every 82 msec) while one of the buttons is being actuated. The dimmer switch 200 is operable to control the lighting load 204 in response to the packets transmitted in the IR signals 206. Specifically, the dimmer switch 200 turns on and turns off the lighting load 204 in response to an actuation of the on button 232 and the off button 234, respectively. The dimmer switch 200 begins to raise or lower the lighting intensity L of the lighting load 204 in response to the raise button 236 and the lower button 238, respectively, being pressed.

The dimmer switch 200 is able to operate in the energy-saver mode and also in a normal mode of operation. The dimmer switch 200 is operable to switch between the modes of operation in response to packets transmitted by the remote control 230 via the IR signals 206. Specifically, the dimmer switch 200 is operable to change from the normal mode to the energy-saver mode in response to a transitory actuation of the energy-saver mode button 240 of the remote control 230. When the dimmer switch 200 is in the energy-saver mode, the dimmer switch illuminates an energy-saver mode visual indicator 220. For example, the visual indicator 220 may be shaped like a leaf (as shown in FIG. 6) and may be colored green. Alternatively, the When the dimmer switch 200 is operating in the normal mode, the dimmer switch 200 sets the high-end intensity L_{HE} to the nominal high-end intensity L_{HE-NOM} (i.e., approximately 92%), such that the dimmer switch is operable to adjust the intensity of the lighting load 204 across the dimming range between the low-end intensity L_{LE} and the nominal high-end intensity L_{HE-NOM}. When the dimmer switch 200 is switched to the energy-saver mode, the dimmer switch 200 sets the high-end intensity L_{HE} to the reduced high-end intensity L_{HE-ES} (i.e., approximately 85%). The dimmer switch 200 rescales the dimming range between the low-end intensity L_{LE} and the reduced high-end intensity L_{HE-ES} and controls the intensity of the lighting load 204 between the low-end intensity L_{LE} and the reduced high-end intensity L_{HE-ES}.

The dimmer switch 200 is operable to switch from the energy-saver mode to the normal mode in response to a non-transitory actuation of the energy-saver mode button 240 of the remote control 230 (e.g., a press and hold of the energy-saver mode button for a predetermined period of time T_{ES-EXIT}, such as five seconds). For example, the dimmer switch 200 may blink the visual indicator 220 while the energy-saver mode button 240 of the remote control 230 is being pressed in order to switch from the energy-saver mode to the normal mode. The dimmer switch 200 stops illuminating the energy-saver mode visual indicator 220 when the dimmer switch changes back to the normal mode. The dimmer switch 200 sets the high-end intensity L_{HE} to the nominal high-end intensity L_{HE-NOM} and rescales the dimming range between the low-end intensity L_{LE} and the nominal high-end intensity L_{NOM-ES}.

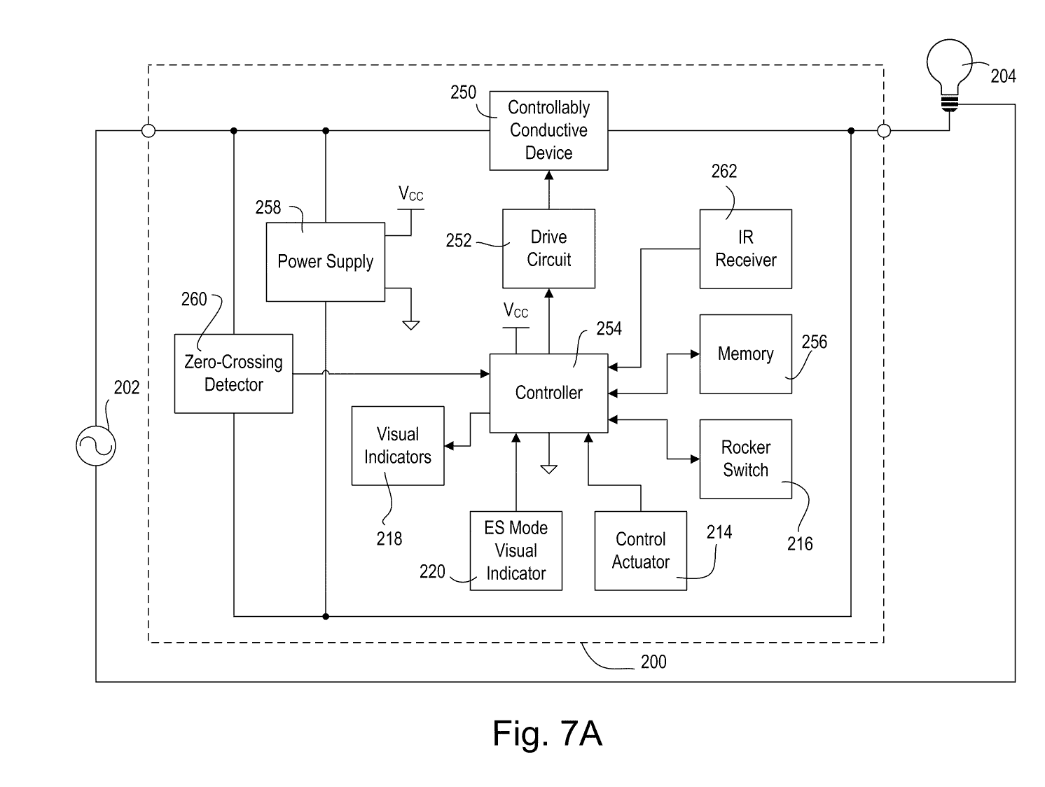

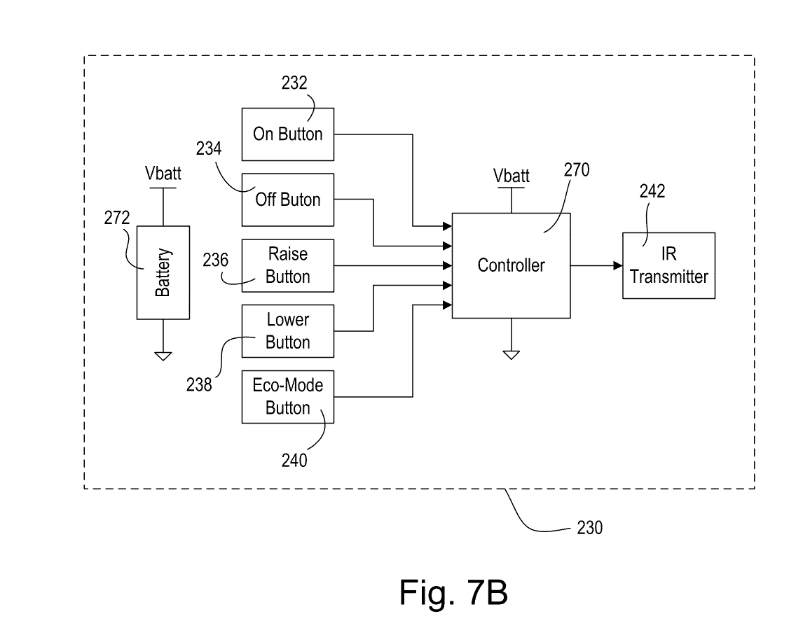

FIG. 7A is a simplified block diagram of the dimmer switch 200. The dimmer switch 200 comprises a controllably conductive device 250 coupled in series electrical connection between the AC power source 202 and the lighting load 204 for control of the power delivered to the lighting load. The controllably conductive device 250 may comprise any suitable type of bidirectional semiconductor switch, such as, for example, a triac, a field-effect transistor (FET) in a rectifier bridge, or two FETs in anti-series connection. The controllably conductive device 250 includes a control input coupled to a drive circuit 252. The input provided to the control input will render the controllably conductive device 250 conductive or non-conductive, which in turn controls the power supplied to the lighting load 204.

The drive circuit 252 provides control inputs to the controllably conductive device 250 in response to command signals from a controller 254. The controller 254 may be implemented as a microcontroller, a microprocessor, a programmable logic device (PLD), an application specific integrated circuit (ASIC), a field-programmable gate array (FPGA), or any suitable processing device. The controller 254 receives inputs from the control actuator 214 and the rocker switch 216 and controls the visual indicators 218, 220. The controller 254 is also coupled to a memory 256 for storage of the preset intensity L_{PRE} of lighting load 204. A power supply 258 generates a direct-current (DC) voltage V_{CC} for powering the controller 254, the memory 256, and other low-voltage circuitry of the dimmer switch 200.

A zero-crossing detector 260 determines the zero-crossings of the input AC waveform from the AC power supply 202. A zero-crossing is defined as the time at which the AC supply voltage transitions from positive to negative polarity, or from negative to positive polarity, at the beginning of each half-cycle. The controller 254 provides the control inputs to the drive circuit 252 to operate the controllably conductive device 250 (i.e., to provide voltage from the AC power supply 202 to the lighting load 204) at predetermined times relative to the zero-crossings of the AC waveform. The dimmer switch 200 further comprises an IR receiver 262 for receiving the IR signals 206 from the remote control 230 via the IR lens 219. The controller 254 receives inputs from the IR receiver 252 and is operable to control the controllably conductive device 250 in response to the packets received via the IR signals 206.

FIG. 7B is a simplified block diagram of the remote control 230. The remote control 230 comprises a controller 270, which is operable to receive inputs from the on button 232, the off button 234, the raise button 236, the lower button 238, and the energy-saver mode button 240. The controller 270 is coupled to the IR transmitter 242, such that the IR transmitter is operable to transmit a packet to the dimmer switch 200 via the IR signals 206 in response to an actuation of one of the on button 232, the off button 234, the raise button 236, the lower button 238, and the energy-saver mode button 240. A battery 272 provides a DC voltage V_{BATT} for powering the controller 270 and other low-voltage circuitry of the remote control 230.

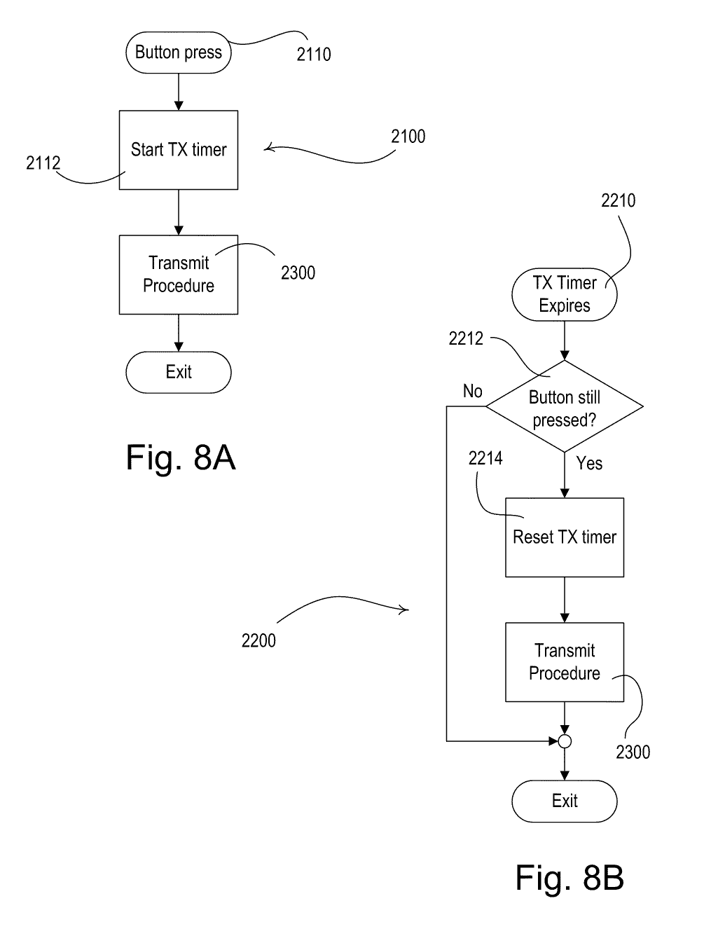

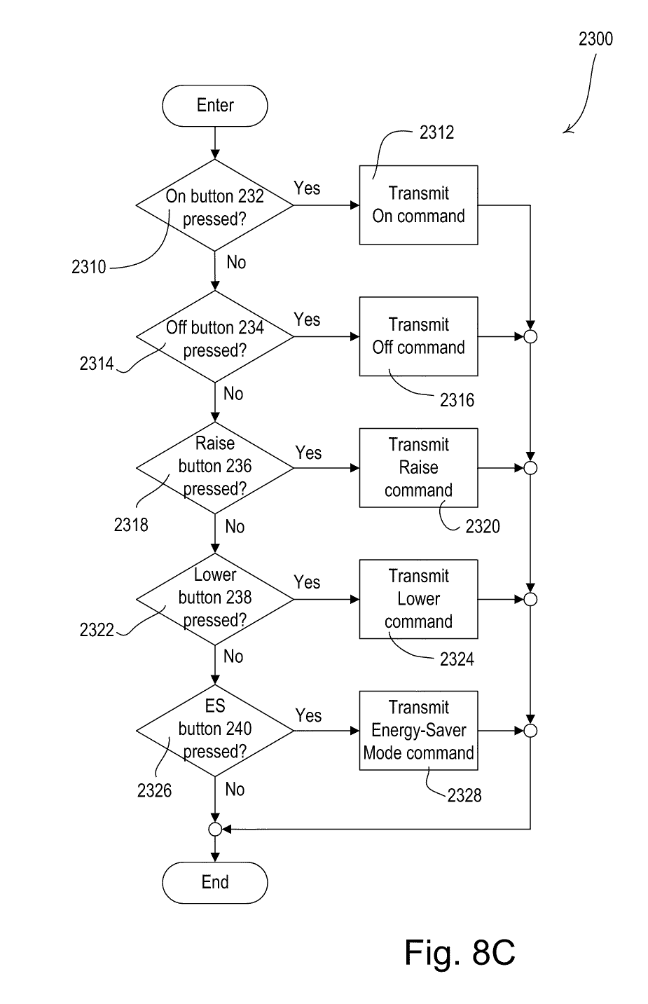

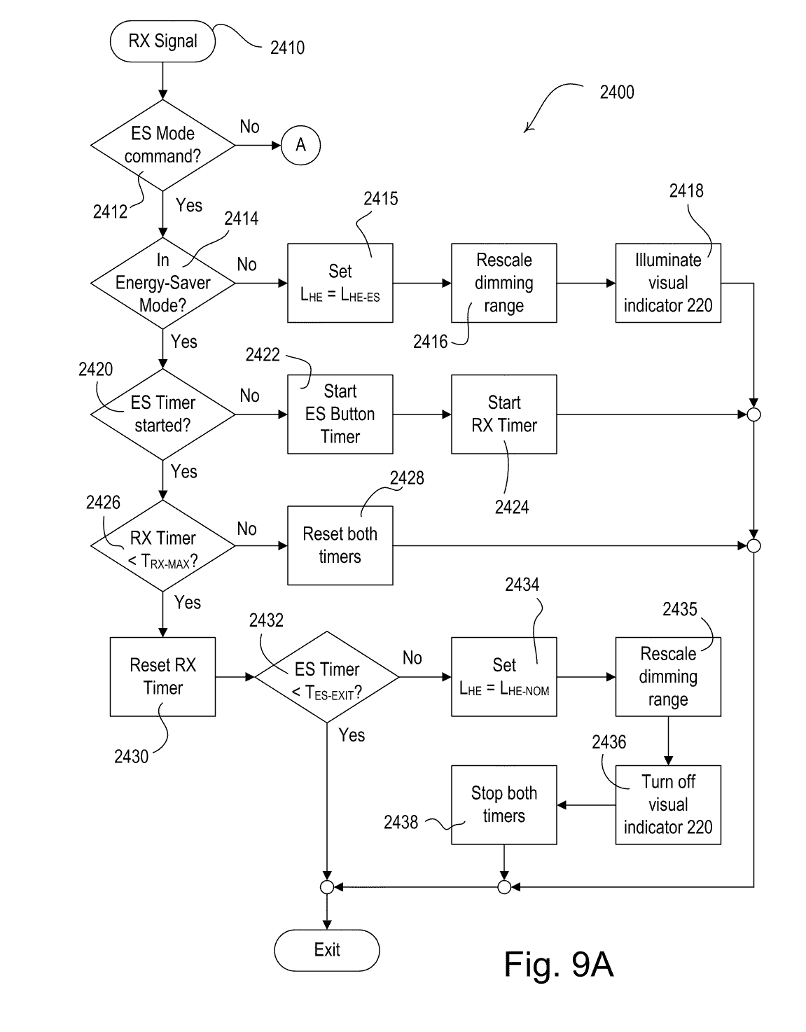

FIG. 8A is a simplified flowchart of a button procedure 2100 executed by the controller 270 of the remote control 230 when one of the on button 232, the off button 234, the raise button 236, the lower button 238, and the energy-saver mode button 240 is actuated at step 2110. As previously mentioned, the remote control 230 transmits packets to the dimmer switch 200 periodically (i.e., approximately every 82 msec). The controller 270 uses a transmit (TX) timer to keep track of when to transmit the packets. At step 2112 of the button procedure 2100, the controller 270 initializes the TX timer (e.g., to approximately 82 msec) and starts the timer decreasing with respect to time. The controller 270 then executes a transmit procedure 2300 (which will be described in greater detail below with reference to FIG. 8C), before the button procedure 2100 exits.

FIG. 8B is a simplified flowchart of a TX timer procedure 2200 that is executed by the controller 270 of the remote control 230 when the TX timer expires at step 2210. If the button that was actuated to start the TX timer is not still being actuated at step 2212, the TX timer procedure 2200 simply exits. However, if the button is still being actuated at step 2212, the controller 270 resets the TX timer (i.e., to approximately 82 msec) at step 2214 and executes the transmit procedure 2300, before the TX timer procedure 2200 exits.

FIG. 8C is a simplified flowchart of the transmit procedure 2300 executed by the controller 270 of the remote control 230. If the on button 232 is pressed at step 2310, the controller 270 transmits a packet with an on command at step 2312 and the transmit procedure 2300 exits. If the on button 232 is not pressed at step 2310, but the off button 234 is pressed at step 2314, the controller 270 transmits a packet with an off command at step 2316 and the transmit procedure 2300 exits. If the off button 234 is not pressed at step 2314, but the raise button 236 is pressed at step 2318, the controller 270 transmits a packet with a raise command at step 2320 and the transmit procedure 2300 exits. If the lower button 238 is pressed at step 2322, the controller 270 transmits a packet with a lower command at step 2324 and the transmit procedure 2300 exits. If the energy-saver mode button 240 is pressed at step 2326, the controller 270 transmits a packet with an energy-saver mode command at step 2328 and the transmit procedure 2300 exits.

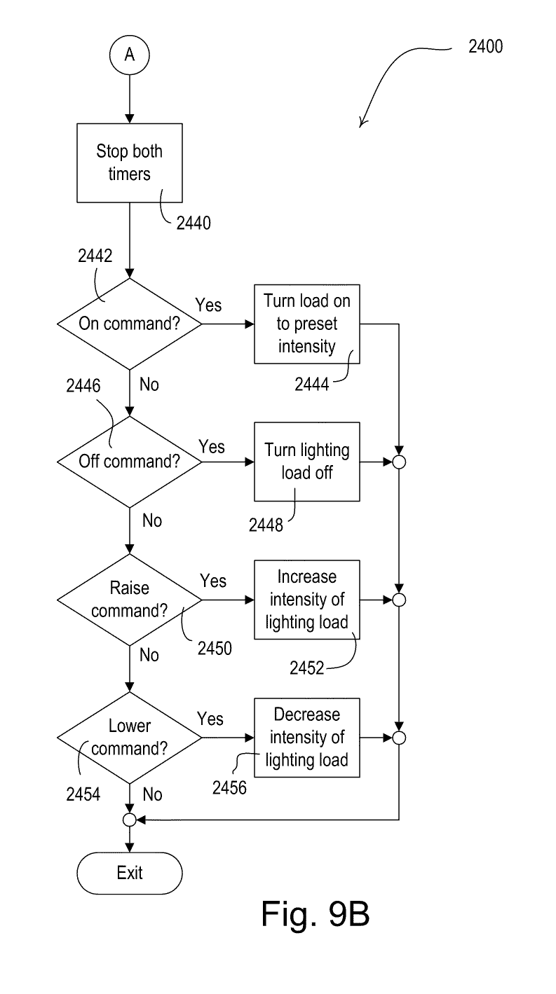

FIGS. 9A and 9B are simplified flowcharts of a receive procedure 2400 executed by the controller 254 of the dimmer switch 200 in response to receiving a packet from the remote control 230 at step 2410. If the received packet includes an energy-saver (ES) command at step 2412 and the dimmer switch 200 is not presently in the energy-saver mode at step 2414 (i.e., the dimmer switch is in the normal mode of operation), the controller 254 changes to the energy-saver mode by setting the high-end lighting intensity L_{HE} equal to the reduced high-end intensity L_{HE-ES} (i.e., approximately 85%) at step 2415 and resealing the dimming range between the low-end intensity L_{LE} and the reduced high-end intensity L_{HE-ES} at step 2416. Next, the controller 254 illuminates the visual indicator 220 at step 2418 and the receive procedure 2400 exits.

If the dimmer switch 200 is in the energy-saver mode at step 2414 when an energy-saver mode command is received at step 2412, the controller 254 determines if an energy-saver mode timer has been started at step 2420. The controller 254 uses the energy-saver mode timer to determine if the energy-saver mode button 240 of the remote control 230 has been pressed and held for the length of the predetermined period of time T_{ES-EXIT} (i.e., five seconds) to thus determine if the controller 254 should exit the energy-saver mode and enter the normal mode. If the controller 254 is in the energy-saver mode at step 2414 and the energy-saver mode timer has not been started at step 2420, the controller initializes the energy-saver mode timer to zero seconds and starts the timer increasing in value with respect to time at step 2422. Next, the controller 254 initializes a receive (RX) timer to zero seconds and starts the timer increasing with respect to time at step 2424. The RX timer is used to keep track of the time between two consecutively-received energy-saver mode commands. The RX timer is reset each time that an energy-saver mode command is received while the dimmer switch 200 is in the energy-saver mode. If there is greater than a predetermined amount of time T_{RX-MAX} (e.g., approximately 300 msec) between any two consecutive energy-saver mode commands, the controller 254 restarts the energy-saver mode timer as will be discussed below. Referring back to FIG. 9A, after the controller 254 starts the energy-saver mode timer at step 2422 and the RX timer at step 2424, the receive procedure 2400 exits.

If the energy-saver mode timer has been started at step 2420, but the RX timer is not less than the predetermined amount of time T_{RX-MAX} at step 2426, the controller 254 resets both the energy-saver mode timer and the RX timer at step 2428 and the receive procedure 2400 exits. If the RX timer is less than the predetermined amount of time T_{RX-MAX} at step 2426, the controller 254 resets only the RX timer at step 2430. If the energy-saver timer is less than the predetermined period of time T_{ES-EXIT} (i.e., five seconds) at step 2432, the receive procedure 2400 simply exits. However, if the energy-saver timer is greater than or equal to the predetermined period of time T_{ES-EXIT} at step 2432, the controller 254 determines that the energy-saver mode button 240 has been held for five seconds. Accordingly, the controller 254 changes to the normal mode of operation by setting the high-end lighting intensity L_{HE} equal to the nominal high-end intensity L_{HE-NOM} (i.e., approximately 92%) at step 2434 and resealing the dimming range between the low-end intensity L_{LE} and the nominal high-end intensity L_{HE-NOM} at step 2435. The controller 254 then stops illuminating the visual indicator 220 at step 2436 and stops both the energy-saver mode timer and the RX timer at step 2438, before the receive procedure 2400 exits.

Referring to FIG. 9B, if the dimmer switch 210 receives a packet that does not include an energy-saver mode command at step 2412, the controller 256 stops both the energy-saver mode timer and the RX timer at step 2440. If the received packet includes an on command at step 2442, the dimmer switch 200 turns on the lighting load 204 to the preset intensity at step 2444 and the receive procedure 2400 exits. If the received packet includes an off command at step 2446, the dimmer switch 200 turns off the lighting load 204 at step 2448 and the receive procedure 2400 exits. If the received packet includes a raise command at step 2450, the dimmer switch 200 increases the intensity of the lighting load 204 by a predetermined amount at step 2452 before the receive procedure 2400 exits. If the received packet includes a lower command at step 2454, the dimmer switch 200 decreases the intensity of the lighting load 204 by a predetermined amount at step 2456 and the receive procedure 2400 exits.

In summary, the dimmer switch 200 of the second embodiment provides a first manually-operable control structure (i.e., the rocker switch 216) for adjusting the present lighting intensity L of the lighting load 204 between the low-end intensity L_{LE} and the high-end intensity L_{HE}. The remote control 230 further provides a second manually-operable control structure (i.e., the energy-saver mode button 240) for adjusting the dimmer switch 200 between the normal mode (i.e., having the nominal high-end intensity L_{HE-NOM}) and the energy-saver mode (i.e., having the reduced high-end trim intensity L_{HE-ES}). When the energy-saver mode button 240 of the remote control 230 is actuated to change the dimmer switch 200 from the normal mode to the energy-saver mode, the present lighting intensity L of the lighting load 204 is decreased by a reduction amount (i.e., from an initial lighting intensity to a resulting lighting intensity). The reduction amount and the resulting lighting intensity of the lighting load 204 are dependent upon (e.g., proportional to) the initial lighting intensity.

Alternatively, the dimmer switch 200 may be operable to change between the normal mode and the energy-saver mode in response to an actuation of the control actuator 214. For example, the dimmer switch 200 could change from the normal mode to the energy-saver mode (and vice versa) in response to a plurality of consecutive transitory actuations of the control actuator 214 in quick succession (e.g., four quick actuations). Further, the control actuator 214 of the dimmer switch 200 could be colored green.

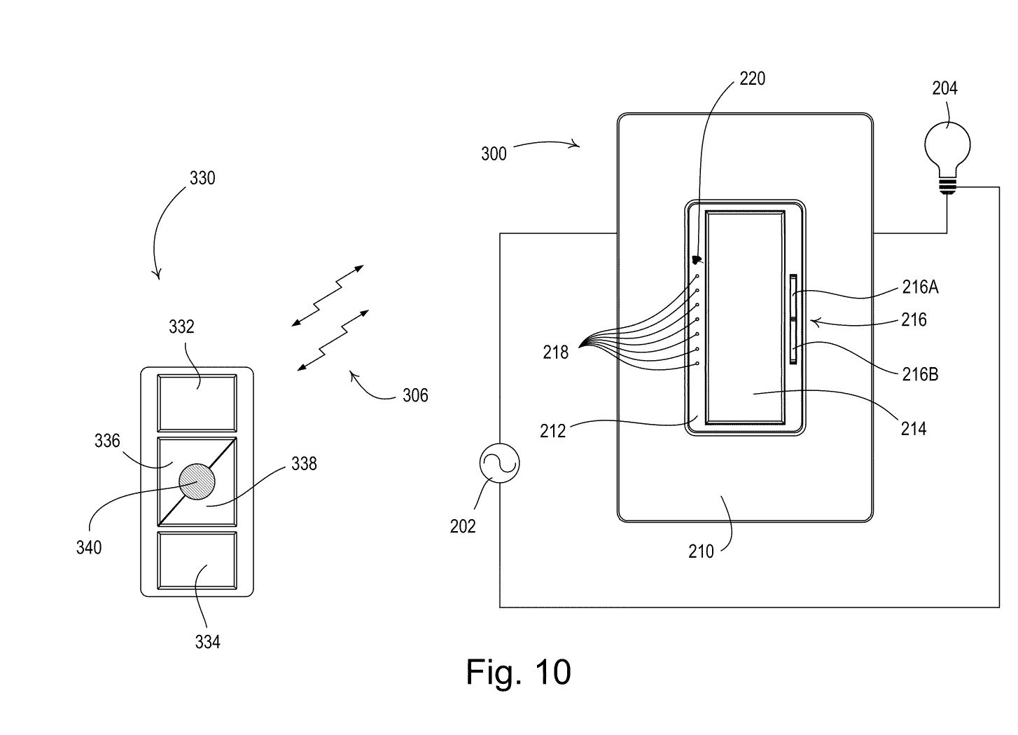

FIG. 10 shows a front view of a smart wallbox dimmer switch 300 that provides a visual indication that the dimmer switch is in an energy-saver mode according to a third embodiment of the present invention. The dimmer switch 300 is operable to receive radio-frequency (RF) signals 306 from an RF remote control 330. The dimmer switch 300 comprises an RF receiver (not shown), while the remote control 330 comprises an RF transmitter (not shown) to allow for one-way RF communication between the remote control and the dimmer switch. The RF receiver of the dimmer switch 300 and the RF transmitter of the remote control 330 are each coupled to internal RF antennas to allow for receipt and transmission of RF signals, respectively. Examples of antennas for wall-mounted dimmer switches are described in greater detail in U.S. Pat. No. 5,982,103, issued Nov. 9, 1999, and U.S. Pat. No. 7,362,285, issued Apr. 22, 2008, both entitled COMPACT RADIO FREQUENCY TRANSMITTING AND RECEIVING ANTENNA AND CONTROL DEVICE EMPLOYING SAME. The entire disclosures of both patents are hereby incorporated by reference.

The remote control 330 comprises an on button 332, an off button 334, a raise button 336, a lower button 338, and an energy-saver (ES) mode button 340, which may be colored, for example, green. The remote control 330 transmits packets via the RF signals 306 to the dimmer switch 300 in response to actuations of any of the buttons 330-340. Each packet transmitted by the remote control 330 includes a preamble, a serial number associated with the remote control, and an appropriate command. During a setup procedure, the dimmer switch 300 is associated with one or more remote controls 330. The dimmer switch 300 is then responsive to packets containing the serial number of the remote control 330 to which the dimmer switch is associated. The setup procedure is described in greater detail in co-pending, commonly-assigned U.S. patent application Ser. No. 11/559,166, filed Nov. 13, 2006, entitled RADIO-FREQUENCY LIGHTING CONTROL SYSTEM, the entire disclosure of which is hereby incorporated by reference.

The dimmer switch 300 is operable to switch from the normal mode to the energy-saver mode in response to a transitory actuation of the energy-saver mode button 340 of the remote control 330. The dimmer switch 300 is operable to switch from the energy-saver mode to the normal mode in response to a non-transitory actuation of the energy-saver mode button 340 of the remote control 330 (e.g., a press and hold of the energy-saver mode button for a predetermined period of time T_{ES-EXIT}, such as ten seconds).

Alternatively, the RF receiver of the dimmer switch 300 and the RF transmitter of the remote control 330 could both comprise RF transceivers to allow for two-way RF communication between the remote control and the dimmer switch. An example of a two-way RF lighting control systems is described in greater detail in commonly-assigned U.S. Pat. No. 5,905,442, issued on May 18, 1999, entitled METHOD AND APPARATUS FOR CONTROLLING AND DETERMINING THE STATUS OF ELECTRICAL DEVICES FROM REMOTE LOCATIONS, the entire disclosure of which is hereby incorporated by reference.

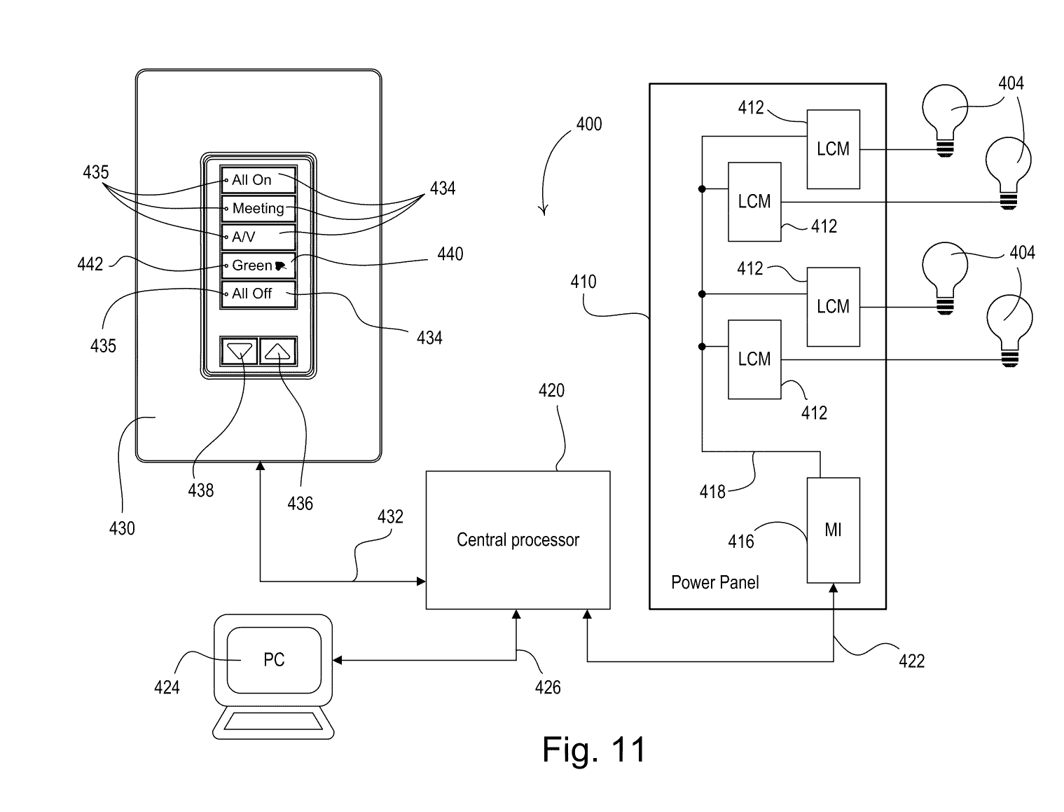

FIG. 11 is a simplified block diagram of a centralized lighting control system 400 that is able to operate in an energy-saver mode according to a fourth embodiment of the present invention. The lighting control system 400 comprises a power panel 410 having a plurality of load control modules (LCMs) 412 (i.e., load control devices). Each load control module 412 is coupled to a lighting load 404 and includes a dimmer circuit for control of the amount of power delivered to the lighting load. Alternatively, each load control module 412 may be coupled to more than one lighting load 404, for example, four lighting loads, and may comprise multiple dimmer circuits for individually controlling the amount of power delivered to each of the lighting loads. The power panel 410 also comprises a module interface (MI) 416, which controls the operation of the load control modules 412 via digital signals transmitted across a power module communication link 418.

The lighting control system 400 comprises a central processor 420, which controls the operation of the lighting control system, specifically, the amount of power delivered to each of the lighting loads 404 by the load control modules 412. The central processor 420 communicates with the module interface 416 of the power panel 410 via an MI communication link 422. The module interface 416 directs the load control modules 412 to adjust the intensities of the lighting loads 404 in response to digital messages received from the central processor 420 via the MI communication link 422. The central processor 420 may also be coupled to a personal computer (PC) 424 via a PC communication link 426. The PC 424 executes a graphical user interface (GUI) software that allows a user of the lighting control system 400 to setup and monitor the lighting control system. Typically, the GUI software creates a database defining the operation of the lighting control system 400 and the database is downloaded to the central processor 420 via the PC communication link 426. The central processor 420 includes a non-volatile memory for storing the database. An example of a centralized lighting control system is described in greater detail in U.S. patent application Ser. No. 11/870,783, filed Oct. 11, 2007, entitled METHOD OF BUILDING A DATABASE OF A LIGHTING CONTROL SYSTEM, the entire disclosure of which is hereby incorporated by reference.

The lighting control system 400 further comprises a keypad 430 coupled to the central processor 420 via a control device communication link 432. The keypad 430 comprises a plurality of preset buttons 434 and corresponding preset button visual indicators 435, which may be illuminated, for example, by LEDs (not shown) inside the keypad. The keypad 430 transmits digital messages including preset commands to the central processor 420 in response to actuations of the preset buttons 434. The central processor 420 is operable to control the intensities of the lighting loads 404 according to a lighting preset (or “scene”) selected by an actuation of one of the preset buttons 434. The central processor 420 controls each of the lighting loads 404 to a specific preset intensity depending upon preset information in the database stored in memory. After adjusting the intensities of the lighting loads 404, the central processor 420 transmits a feedback message to the keypad 430, such that the keypad illuminates the preset visual indicator 435 provided on the preset button 434 that was pressed to provide feedback to a user. The preset buttons 434 may be labeled with text that is representative of the specific lighting preset that is selected in response to an actuation of the preset button. Further, the preset buttons 434 may be backlight by LEDs mounted behind the buttons, such that the text on the preset buttons is visible in a dark environment.

The keypad 430 also comprises a raise button 436 and a lower button 438. The central processor 420 is operable to raise or lower the intensities of all of the lighting loads 404 (or a subset of the lighting loads) in response to actuations of the raise button 436 and the lower button 438, respectively.

According to the fourth embodiment of the present invention, the keypad 430 comprises an energy-saver mode button 440 and a corresponding energy-saver mode visual indicator 442, which is illuminated when the lighting control system 400 is operating in the energy-saver mode. The energy-saver mode button 440 may be labeled with the text “Green” and an icon of a leaf (as shown in FIG. 11). Further, the energy-saver mode button 440 may be backlight with a green LED, such that the text and the leaf icon are illuminated green. The energy saver mode visual indicator 442 is provided on the energy-saver mode button 440 and may be illuminated by a green LED. Alternatively, the energy-saver mode visual indicator 442 may be positioned adjacent the energy-saver mode button 440.

The central processor 420 is operable to switch the lighting control system 400 between the normal mode of operation and the energy-saver mode in response to actuations of the energy-saver mode button 440. The central processor 420 is operable to reduce the intensities of all (or some) of the lighting loads 404 by predetermined amounts when the lighting control system 400 is operating in the energy-saver mode. For example, the central processor 420 may scale the intensities of all (or some) of the lighting loads 404 by a predetermined scaling factor (e.g., approximately 85%) when the lighting control system 400 is operating in the energy-saver mode. The central processor 420 transmits an energy-saver mode feedback digital message to the keypad 430 after changing to the energy-saver mode, such that the energy-saver mode visual indicator 442 is illuminated when the lighting control system 400 is operating in the energy-saver mode.

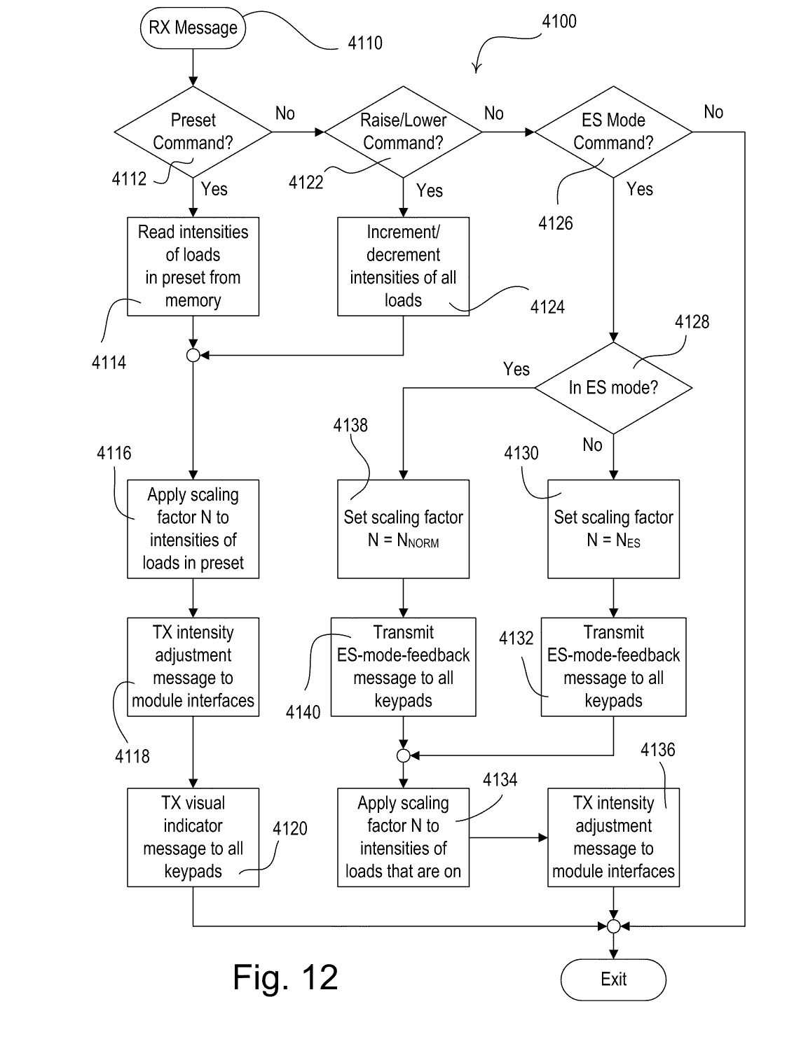

FIG. 12 is a simplified flowchart of a control procedure 4100 executed by the central processor 420 in response to receiving a digital message from the keypad 430 via the control device communication link 432 at step 4110. If the received digital message includes a preset command at step 4112, the processor 420 reads from memory the specific preset intensities of each of the loads according to the selected lighting preset at step 4114. Next, the processor 420 applies a scaling factor N to the specific intensities of the selected lighting preset at step 4116. The scaling factor N is set equal to a normal mode scaling factor N_{NORM} (e.g., 1.00) during the normal mode and equal to an energy-saver mode scaling factor N_{ES} (e.g., 0.85) during the energy-saver mode. After applying the scaling factor N at step 4116, the processor 420 transmits digital messages including appropriate intensity adjustment commands to the module interface 416 at step 4118, such that the load control modules 412 adjust the intensities of the lighting loads 404 according to the scaled intensities determined at step 4116. The processor 420 then transmits a feedback digital message to the keypad 430 at step 4120, such that the keypad 430 illuminates the appropriate preset button visual indicator 435.

If the received digital message does not include a preset command at step 4112, but includes a raise or lower command at step 4122, the processor 420 respectively increments or decrements the intensities of all of the lighting loads 404 at step 4124. The processor 420 then applies the scaling factor N to all of the intensities at step 4116, transmits appropriate intensity adjustment commands to the module interface 416 at step 4118, and transmits a feedback digital message to the keypad 430 at step 4120, before the control procedure 4100 exits.

If the received digital message includes an energy-saver (ES) mode command at step 4126 and the processor 420 is in the normal mode (i.e., not in the energy-saver mode) at step 4128, the processor sets the scaling factor N to the energy-saver mode scaling factor N_{ES} (i.e., 0.85) at step 4130 and transmits an energy-saver mode feedback message to the keypad 430 at step 4132, such that the keypad illuminates the energy-saver mode visual indicator 442 while in the energy-saver mode. The processor 420 then applies the new scaling factor N to the intensities of all of the lighting loads 404 that are on at step 4134 and transmits digital messages including intensity adjustment commands to the module interface 416 at step 4136, before the control procedure 4100 exits. If the processor 420 is in the energy-saver mode at step 4128, the processor sets the scaling factor N to the normal mode scaling factor N_{NORM} (e.g., 1.00) at step 4138 and transmits an energy-saver mode feedback message to the keypad 430 at step 4140, such that the keypad stops illuminating the energy-saver mode visual indicator 442 while in the normal mode of operation. The processor 420 then applies the new scaling factor N at step 4134 and transmits the appropriate digital messages at step 4136, before the control procedure 4100 exits.

The communication links of the lighting control system 400 (i.e., the MI communication link 422, the PC communication link 426, and the control device communication link 428) may comprise, for example, four-wire digital communication links, such as a RS-485 communication links. Alternatively, the communication links may comprise two-wire digital communication links, such as, DALI communication links, or wireless communication links, such as, radio-frequency (RF) or infrared (IR) communication links. An example of an RF lighting control system is described in greater detail in U.S. patent application Ser. No. 12/033,223, filed Feb. 19, 2008, entitled COMMUNICATION PROTOCOL FOR A RADIO-FREQUENCY LOAD CONTROL SYSTEM, the entire disclosure of which is hereby incorporated by reference.

Alternatively, the lighting control system 400 could comprise a distributed lighting control system, which, for example, would not include the central processor 420. The database that defines the operation of such a distributed lighting control system would be distributed in each of the control devices of the distributed lighting control system (i.e., all or a portion of the database would be stored in each of the control devices). Further, the lighting control system 400 could comprise a plurality of dimmer switches operable to be coupled to the control device link 432, such that the dimmer switches could directly receive digital message from the keypad 430. An example of a distributed lighting control system is described in greater detail in commonly-assigned U.S. Pat. No. 6,803,728, issued Oct. 12, 2004, entitled SYSTEM FOR CONTROL OF DEVICES, the entire disclosure of which is hereby incorporated by reference.

Accordingly, the keypad 430 of the lighting control system 400 of the fourth embodiment provides a first manually-operable control structure (i.e., the preset buttons 434, the raise button 436, and the lower button 438) for adjusting the intensities of the lighting loads 404. The keypad 430 further provides a second manually-operable control structure (i.e., energy-saver mode button 440) for adjusting the lighting control system 400 between the normal mode and the energy-saver mode. When the energy-saver mode button 440 of the keypad 430 is actuated to change the lighting control system 400 from the normal mode to the energy-saver mode, the intensities of the lighting loads 404 are all decreased by reduction amounts, i.e., the resulting lighting intensity of each lighting load is dependent upon (e.g., proportional to) the initial lighting intensity of the lighting load.

In addition, the processor 420 of the lighting control system 400 could be coupled to a wide area network (WAN), such as the Internet, for example, via an Ethernet communication link. The processor 420 could then be operable to receive from an electrical utility company via the Ethernet communication link a demand response command directing the lighting control system 400 to consume less power. The processor 420 could be operable to change the lighting control system 400 from the normal mode to the energy-saver mode in response to receiving the demand response command. Examples of lighting control systems that are responsive to demand response commands are described in greater detail in U.S. patent application Ser. No. 11/870,889, filed Oct. 11, 2007, entitled METHOD OF LOAD SHEDDING TO REDUCE THE TOTAL POWER CONSUMPTION OF A LOAD CONTROL SYSTEM, and U.S. patent application Ser. No. 11/938,604, filed Nov. 12, 2007, entitled METHOD OF COMMUNICATING A COMMAND FOR LOAD SHEDDING OF A LOAD CONTROL SYSTEM

Although the present invention has been described in relation to particular embodiments thereof, many other variations and modifications and other uses will become apparent to those skilled in the art. Therefore, the present invention should not be limited by the specific disclosure herein.

What is claimed is:

1. A system for controlling the amount of power delivered from a power source to a lighting load for adjusting an intensity of the lighting load, the system comprising:
a controllably conductive device adapted to be coupled in series electrical connection between the source and the load for controlling the amount of power delivered to the load;
a control circuit operatively coupled to the controllably conductive device for adjusting the intensity of the lighting load, the control circuit operable to change between a normal mode of operation and an energy-saver mode; and
a visual indicator operable to provide a visual indication that the control circuit is in the energy-saver mode of operation;
wherein the control circuit controls the intensity of the lighting load between a minimum intensity and a first maximum intensity when the dimmer switch is in the normal mode of operation, and between the minimum intensity and a second maximum intensity when the dimmer switch is in the energy-saver mode, the second maximum intensity less than the first maximum intensity.

2. The system of claim 1, further comprising:
a dimmer switch adapted to be coupled between the source and the load for adjusting the intensity of the lighting load, the dimmer switch comprising the controllably conductive device, the control circuit, and the visual indicator.

3. The system of claim 2, wherein the control circuit comprises a microcontroller and the visual indicator is illuminated by a light-emitting diode, the microcontroller operatively coupled to the light-emitting diode for illuminating the visual indicator when the control circuit is in the energy-saver mode of operation.

4. The system of claim 3, further comprising:
a remote control comprising an actuator, the remote control operable to transmit a wireless signal to the dimmer switch in response to an actuation of the actuator;
wherein the dimmer switch is operable to change from the normal mode of operation to the energy-saver mode in response to receiving the wireless signal.

5. The system of claim 4, wherein the dimmer switch is operable to change from the normal mode of operation to the energy-saver mode in response to receiving the wireless signal when the actuation of the actuator comprises a single transitory actuation of the actuator.

6. The system of claim 4, wherein the dimmer switch is operable to change from the energy-saver mode to the normal mode in response to receiving the wireless signal when the actuation of the actuator comprises a non-transitory actuation of the actuator.

7. The system of claim 4, wherein the actuator is colored green.

8. The system of claim 3, wherein the dimmer switch further comprises an actuator, the dimmer switch operable to change from the normal mode of operation to the energy-saver mode in response to an actuation of the actuator.

9. The system of claim 8, wherein the dimmer switch is operable to change from the normal mode of operation to the energy-saver mode when the actuation of the actuator comprises a plurality of consecutive transitory actuations of the actuator.

10. The system of claim 8, wherein the dimmer switch is operable to change from the energy-saver mode to the normal mode when the actuation of the actuator comprises a plurality of consecutive transitory actuations of the actuator.

11. The system of claim 8, wherein the actuator is colored green.

12. The system of claim 3, wherein the visual indicator is illuminated green.

13. The system of claim 3, wherein the visual indicator is shaped like a leaf.

14. The system of claim 2, wherein the dimmer switch comprises an actuator, the dimmer switch operable to change from the normal mode of operation to the energy-saver mode in response to an actuation of the actuator, such that the dimmer switch operates in the normal mode when the actuator is in a first position and in the energy-saver mode when the actuator is in a second position.

15. The system of claim 14, wherein the power source comprises an AC power source and the dimmer switch further comprises:
a timing circuit coupled in parallel electrical connection with the controllably conductive device for generating a firing voltage signal, the timing circuit comprising a mechanical switch for adjusting a rate at which a magnitude of the firing voltage signal increases each half-cycle of the AC power source; and
a triggering circuit for rendering the controllably conductive device conductive each half-cycle of the AC power source in response to the firing voltage signal;
wherein the actuator comprises a user-accessible adjustment actuator operable to actuate the mechanical switch for changing the dimmer switch between the normal mode of operation and the energy-saver mode.

16. The system of claim 15, wherein the visual indicator comprises a mechanical flag.

17. The system of claim 1, further comprising:
a keypad having an actuator, the visual indicator positioned on or adjacent to the actuator;
wherein the control circuit is operable to change from the normal mode of operation to the energy-saver mode in response to an actuation of the actuator.

18. The system of claim 17, wherein the control circuit comprises a microcontroller and is provided in a central processor, the central processor operable to receive a digital message from the keypad, such that the central processor is operable to change from the normal mode of operation to the energy-saver mode in response to the digital message received from the keypad.

19. The system of claim 17, wherein the visual indicator of the keypad is illuminated when the control circuit is in the energy-saver mode of operation.

20. The system of claim 17, wherein the actuator is illuminated green.

21. The system of claim 1, wherein the system is operable to receive a demand response command, and the control circuit is operable to change from the normal mode of operation to the energy-saver mode in response to the system receiving the demand response command.

22. A control system for controlling the amount of power delivered to a lighting load from an electrical power source, said system comprising:
a dimmer circuit adapted to be coupled in series electrical connection between said power source and said lighting load for controlling the amount of power delivered to said lighting load;
a first control structure, said dimmer circuit being operable, in response to the operation of said first control structure, to controllably adjust the power applied to said load to an initial value in a range between a high rated value and a lower value;
a second control structure, said dimmer circuit being operable, in response to the operation of said second control structure, to reduce the power applied to said load as set by said first control structure by a reduction amount that is dependent upon said initial value; and
an indicator responsive to said second control structure, said indicator providing a visual indication when said dimmer circuit has reduced the power applied to said load as set by said first control structure by said reduction amount.

23. The control system of claim 22, wherein said second control structure comprises a button.

24. The control system of claim 23, wherein said button is provided on a remote control.

25. The control system of claim 24, wherein said dimmer circuit reduces the power applied to said load by said reduction amount after a single depression of said button.

26. The control system of claim 25, wherein said dimmer circuit ceases to reduce the power applied to said load by said reduction amount after a predetermined length of time of depression of said button.

27. The control system of claim 24, wherein said remote control comprises a keypad.

28. The control system of claim 27, wherein said indicator is provided on said keypad.

29. The control system of claim 28, wherein said indicator comprises a light-emitting diode operable to be illuminated when said dimmer circuit has reduced the power applied to said load as set by said first control structure by said reduction amount.

30. The control system of claim 23, wherein said indicator comprises a light-emitting diode for illuminating said button.

31. The control system of claim 22, wherein said dimmer circuit, said first control structure, and said indicator are mounted in a wall box dimmer switch.

32. The control system of claim 31, wherein said second control structure is provided on a remote control.

33. The control system of claim 31, wherein said reduction amount is proportional to said initial value.

34. The control system of claim 31, wherein said indicator comprises a light-emitting diode operable to be illuminated when said dimmer circuit has reduced the power applied to said load as set by said first control structure by said reduction amount.

35. The control system of claim 22, wherein said control system is mounted in a wallbox dimmer switch.

36. The control system of claim 35, wherein said second control structure is a user-accessible adjustment actuator.

37. The control system of claim 36, wherein said second control structure is a slider actuator.

38. The control system of claim 22, wherein said reduction amount produces a reduction in light output which is substantially imperceptible to the human eye.

39. A wallbox dimmer switch adapted to be coupled between a power source and an electrical load for controlling the amount of power delivered to said electrical load between a maximum value and a minimum value, said wallbox dimmer switch comprising:
a dimmer circuit for controlling the power applied to said load between said maximum value and said minimum value;
a first manually-operable control structure for controlling said dimmer circuit;
a second manually-operable control structure, said dimmer circuit operable to reduce the amount of power applied to said load as called for by said first manually-operable control structure; and
an indicator lamp operable to be illuminated in response to said second manually-operable control structure;
wherein the reduction of the amount of power responsive to the actuation of said second manually-operable control structure is functionally related to the amount of power being supplied to said load when said second manually-operable control structure is actuated.

40. A process of saving energy supplied from a power source to a load, the process comprising the steps of:
providing a dimmer circuit operable to controllably adjust the amount of power applied to said load by the manual operation of a first manually-operable control structure;
operating a second manually-operable control structure to reduce the amount of power applied to said load beyond that called for by said first manually-operable control structure; and
illuminating of an indicator lamp when said second manually-operable control structure is actuated;
wherein said power reduction is functionally related to the amount of power being supplied to said load when said second manually-operable control structure is actuated.

41. The process of claim 40, wherein said load is a lighting load and wherein the reduction of the light of said load caused by the actuation of said second manually-operable control structure is substantially imperceptible to the eye.
